(19) United States
(12) Patent Application Publication
(10) Pub. No.: US 2025/0270380 A1
(43) Pub. Date: Aug. 28, 2025

(54) RUBBER MEMBER, METHOD FOR MANUFACTURING THE SAME, AND METHOD FOR USING THE SAME

(71) Applicant: CANON KABUSHIKI KAISHA, Tokyo (JP)

(72) Inventors: KOICHI SATO, Kanagawa (JP); MAYUMI MIURA, Kanagawa (JP); TAKAYUKI HIRATANI, Tokyo (JP); RYO OGAWA, Kanagawa (JP); YUKIO NAGASE, Tokyo (JP); YOUSUKE TAKUBO, Kanagawa (JP)

(21) Appl. No.: 19/062,718

(22) Filed: Feb. 25, 2025

(30) Foreign Application Priority Data
Feb. 28, 2024 (JP) 2024-028192

(51) Int. Cl. C08J 9/36; B05D 1/02; B05D 1/18; B29C 71/02; C08J 9/00; C08K 3/04

(52) U.S. Cl. CPC C08J 9/365; B05D 1/02; B05D 1/18; C08J 7/044; C08J 7/08; C08J 9/0066; C08K 3/04; B05D 2201/02; B05D 2401/10; C08J 2205/052; C08J 2315/02

(57) ABSTRACT

A rubber member includes foamed fluoro rubber as a base material, wherein a difference between a nitrogen atomic percentage of a surface of the rubber member determined by an X-ray photoelectron spectroscopy (XPS) analysis and a nitrogen atomic percentage of an inside of the rubber member determined by the XPS analysis is 0.5% or more and 7.5% or less.

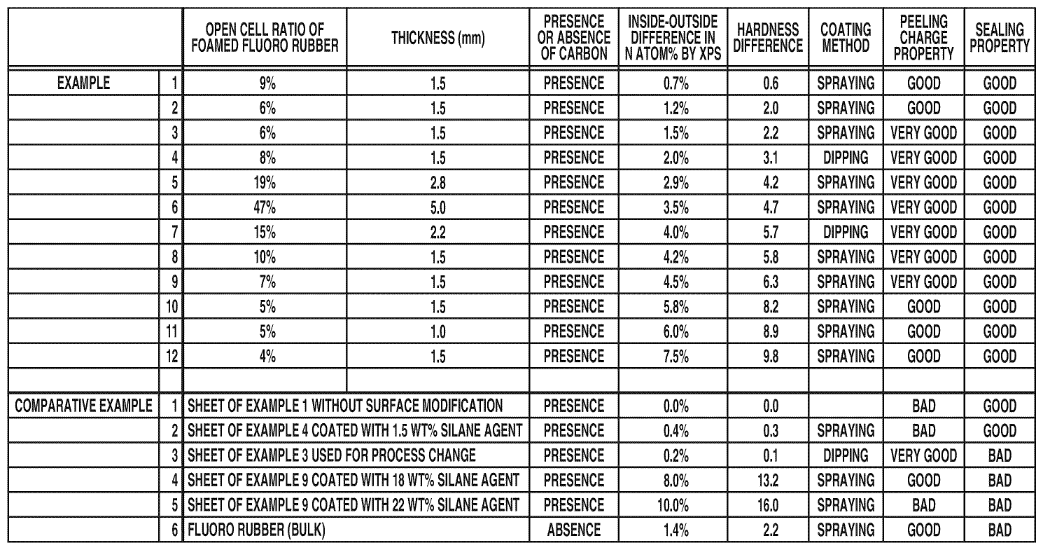

### BACKGROUND

### Technical Field

The present disclosure relates to a rubber member, a method for manufacturing the same, and a method for using the same.

### Description of the Related Art

Foamed fluoro rubber, which has excellent heat resistance, chemical resistance, and low outgassing properties, is widely used in the fields of automobiles, electricity, construction, and the like due to its excellent performance as buffering members, shock mitigation members, pressure relaxation members, sealing members, heat insulating members, and the like.

However, conventional foamed fluoro rubber may strongly charge a counterpart member with which it contacts (see Japanese Patent Application Laid-Open No. 2004-256565, for example).

If such conventional foamed fluoro rubber is used in electrical equipment or device manufacturing equipment, there has been a concern that, when a foamed fluoro rubber member is peeled off from a counterpart member having a fine electrical circuit, the fine electrical circuit may be destroyed due to strong charging.

### SUMMARY

One aspect of the present disclosure is to provide a rubber member that suppresses charging at the time of being peeled off from a member in contact therewith, thereby suppressing damage to the member.

According to an aspect of the present disclosure, a rubber member includes foamed fluoro rubber as a base material, wherein a difference between a nitrogen atomic percentage of a surface of the rubber member determined by an X-ray photoelectron spectroscopy (XPS) analysis and a nitrogen atomic percentage of an inside of the rubber member determined by the XPS analysis is 0.5% or more and 7.5% or less.

Further features of the present disclosure will become apparent from the following description of example embodiments with reference to the attached drawing.

### BRIEF DESCRIPTION OF THE DRAWINGS

The FIGURE is a table illustrating results of examples and comparative examples.

### DESCRIPTION OF THE EMBODIMENTS

Example embodiments are described in detail below with reference to the accompanying drawing. The following example embodiments, however, are non-limiting. Although a plurality of features is described in the example embodiments, not all of the plurality of features is necessarily essential, and the plurality of features may be combined as desired. Furthermore, in the accompanying drawing, the same or similar components are denoted by the same reference numerals, and redundant description will be omitted.

A rubber member according to a first example embodiment of the present disclosure is a rubber member including a foamed fluoro rubber member as a base material, and a difference between a nitrogen atomic percentage of a surface of the rubber member determined by an X-ray photoelectron spectroscopy (XPS) analysis and a nitrogen atomic percentage of an inside of the rubber member determined by the XPS analysis, which is obtained by subtracting the latter from the former, is 0.5% or more and 7.5% or less.

In this case, the foamed fluoro rubber used as the base material is desirably foamed fluoro rubber that has many cells of a closed cell structure and has an open cell ratio that is 50% or less, more desirably 25% or less, further desirably 10% or less.

The rubber member of the present example embodiment desirably contains carbon black.

The rubber member of the present example embodiment is desirably a rubber member in which the difference between the nitrogen atomic percentage of the surface of the member determined by the XPS analysis and the nitrogen atomic percentage of the inside of the member determined by the XPS analysis, which is obtained by subtracting the latter from the former, is 1.5% or more and 4.5% or less.

A method for manufacturing a rubber member according to a second example embodiment is a manufacturing method for manufacturing a rubber member in which an aminosilane agent is applied by a dipping method or a spraying method and alcohol is used as a solvent. Desirably, a monoalcohol having up to four carbon atoms is used in the method manufacturing.

A method for using a rubber member according to a third example embodiment is a method for using a rubber member as a contact member that is capable of being used in contact with any one of members, each including an insulating portion, of quartz, glass, polyamides, polyamines, polyacrylamides, polyvinyl alcohols, poly-N-vinyl polymers, poly(meth)acrylic acids, cellophane, and silk and is capable of being separated from any one of the members.

The first example embodiment will be further described below.

As a foamed fluoro rubber material as the base material used in the present example embodiment, typically, the foamed fluoro rubber discussed in Japanese Patent Application Laid-Open No. 2004-256565 described above can be used, for example. As the fluoro rubber material, fluoro rubber called fluoroelastomer (FKM, ASTM abbreviation), which has a good balance between cost and performance, can usually be used. Of course, depending on an intended use, perfluoroelastomer (FFKM, ASTM abbreviation), which is made entirely of perfluoro and has high heat resistance and high chemical resistance, can also be used although it is expensive. These fluoro rubber materials have high durability, high heat resistance, high chemical resistance, and high oil resistance, and further have high flexibility, and are therefore suitable for use as buffering members, shock mitigation members, pressure relaxation members, sealing members, adhesive members, heat insulating members, and the like.

The fluoro rubber used as the base material in the present example embodiment is a foam. Being a foam, the fluoro rubber is very lightweight and very flexible, and is therefore more suitably adaptable for buffering members, shock mitigation members, pressure relaxation members, sealing members, adhesive members, and heat insulating members. It is well known to those skilled in the art that foams can be formed by the method discussed in the above-described Japanese Patent Application Laid-Open No. 2004-256565, for example.

In the present example embodiment, the porosity of the foam may be 30% or more and 95% or less, desirably 40% or more and 95% or less, and more desirably 50% or more and 90% or less.

The porosity can be calculated by cutting out the foam into a rectangular parallelepiped, specifying its volume, and measuring its weight because the density of the fluoro rubber material is known to be about 1.80 to 1.90 g/ml in the case of FKM, and 1.90 to 2.00 g/ml even in a case where the fluoro rubber material contains carbon black or the like as a filler. If the material is a fully open cell foam, the porosity can be calculated as it is. If the material includes closed cells, the closed cell are all converted into open cells using a large number of sharp needle-like structures, and then all voids are crushed under high pressure, so that the porosity can be calculated from the original volume and the volume after application of the high pressure. Alternatively, the porosity can be calculated by imaging a cross section using an electron microscope and applying image processing.

The size of the voids, or a pore diameter, of the rubber member of the present example embodiment may be required to be suitable for the intended use or the purpose of use, and may desirably be about several μm to about 300 μm. The pore diameter varies, and the pore diameter of about 50 to 100 μm is often used for major pores. However, the pore diameter is not limited to this. In addition, it does not matter if there is a pore that is particularly too small or too large. Such pores, as long as they are few in number, do not have a lot of effect on the characteristics of the rubber member. The pore diameter can be observed with a microscope such as an electron microscope.

The rubber member of the present example embodiment may have either a void structure of open cells or a void structure of closed cells. While both of the structures are high in flexibility, the closed cell structure is more durable in terms of resilience and heat insulation and is suitably used for buffering members, shock mitigation members, pressure relaxation members, sealing members, contact members, and heat insulating members. However, the selection depends on the specific purpose of use and does not exclude the open cell structure. The open cell structure and the closed cell structure are not mutually exclusive. In terms of the open cell ratio, a structure with a high open cell ratio is generally called the open cell structure, and a structure with a low open cell ratio is generally called the closed cell structure. Accordingly, in the present example embodiment, a structure with an open cell ratio of 50% or less is desirably used as the closed cell structure, and the open cell ratio is more desirably 25% or less, and further desirably 10% or less.

The rubber member of the present example embodiment has a porous structure and is extremely flexible and elastic compared to a member having a non-porous structure, i.e., bulk fluoro rubber. Thus, the rubber member can exhibit excellent properties as sealing members, buffering members, heat insulating members, pressure relaxation members, and adhesive members. The present inventors have found that, when the rubber member is used as a sealing member, the rubber member ensures a sealing property due to its great flexibility even in a case where the sealing property of the bulk fluoro rubber breaks due to a torsional force.

The open cell ratio herein can be measured by the method discussed in Japanese Patent Application Laid-Open No. 2022-60895. More specifically, a rubber member of a certain size is submerged in water, placed under a reduced pressure, left to stand for about 10 minutes, and then returned to a normal pressure, so that the open cells are filled with water. In this state, all the absorbed water is squeezed out using two rollers or the like, and the weight of the absorbed water is measured to determine the volume of the absorbed water. The volume is regarded as the volume of the open cells, and is divided by the total volume of the voids obtained from the porosity described above to calculate the open cell ratio in percentage.

The rubber material that can be used in the present example embodiment desirably contains what is called a filler, such as fine particles of carbon black or silica, to adjust physical properties.

The rubber member of the present example embodiment is a rubber member in which the difference between the nitrogen atomic percentage of the surface of the member determined by an XPS analysis and the nitrogen atomic percentage of the inside of the member determined by the XPS analysis is 0.5% or more and 7.5% or less, which is obtained by subtracting the latter from the former. Specifically, such a state can be achieved by chemically modifying a surface portion. The method therefor will be described below.

The rubber member of the present example embodiment is the rubber member in which the difference between the nitrogen atomic percentage of the surface of the member determined by the XPS analysis and the nitrogen atomic percentage of the inside of the member determined by XPS analysis is 0.5% or more and 7.5% or less, which is obtained by subtracting the latter from the former, and the nitrogen content of the surface is higher than the nitrogen content of the inside. Such a state can be achieved by modifying the surface with a chemical modifier having an amine functional group, for example. As a specific example, there is a surface modification method of coating the surface of the foamed fluoro rubber with a silane coupling agent having the amine functional group and thermally treating the surface thereof.

Examples of the silane coupling agent having the amine functional group (also referred to as the aminosilane agent) include:
(C₂H₅O)₃SiC₃H₆—NH₂;
(C₂H5O)₃SiC₃H₆—NH-Ph;
(CH₃O)₂Si(CH₃)—C₃H₆—NH—C₂H₄—NH₂;
(CH₃O)₃SiC₃H₆—NH—C₂H₄—NH₂; and
(CH₃O)₃SiC₃H₆—NH₂.

However, the silane coupling agent is not limited to these. In addition, it is possible to achieve the state in which the surface of the present example embodiment has a large number of nitrogen atoms by coating the surface with a polymer containing the amine functional group as a dilute solution using a solvent. The function of the present example embodiment is implemented by achieving the state in which the surface has a large number of nitrogen atoms. While desirable methods for implementing are listed herein, a method for achieving the state in which the difference between the nitrogen atomic percentage of the surface of the rubber member of the present example embodiment determined by an XPS analysis and the nitrogen atomic percentage of the inside of the member determined by the XPS analysis is 0.5% or more and 7.5% or less, which is obtained by subtracting the latter from the former, is not limited to these.

In performing surface modification with the aminosilane agent, the surface of the rubber member may be treated with plasma or the like in order to suppress deterioration after the surface modification, which is thought to be due to formation of chemical bonds, and to obtain more favorable durability. A rubber member containing carbon black as the filler is desirably used because the aminosilane agent can chemically bond to functional groups present in the carbon black.

Regarding the thickness and the shape of the rubber member in the present example embodiment the surface of which has a higher nitrogen atomic percentage than the inside thereof, the rubber member in a sheet form having a thickness of 0.5 mm or more, desirably 1 to 2 mm or more, is usually used. The thickness as well as the size is to be determined depending on the purpose and a means of sealing or buffering. The thickness of the member in the present example embodiment is not to be considered to be limiting, but is effectively 0.5 mm or more.

Considering a case where the rubber member is not in a sheet form, the upper limit of the thickness depends on an adjacent member, a contact member, or an overall shape including the adjacent member or the contact member when the rubber member is used as a buffering member, shock mitigation member, pressure relaxation member, sealing member, adhesive member, heat insulating member, or the like. The rubber member is not limited to a planar structure or a rectangular parallelepiped structure but is a three-dimensional structure that may include curves and curved surfaces. Considering that the main effect of the present example embodiment is the function of a contact surface with a counterpart member, it is thought that the upper limit of the thickness cannot be limited, and there is no meaning in limiting the upper limit thereof. In short, the rubber member of the present example embodiment has the shape such that a portion that directly contacts the counterpart member can be adapted to a shape of the counterpart member and the other portions can take shape required as a whole.

The rubber member of the present example embodiment needs to have a surface that contacts a counterpart member that may cause a charging failure modified. This produces the effects of the present example embodiment. In the case where the rubber member is in the sheet form, one side that contacts the counterpart member needs to have a high nitrogen atomic percentage, which is a condition of the present example embodiment. Other portions of the rubber member may or may not have a high nitrogen atomic percentage on the surface. Even if the rubber member is in a form other than the sheet form, similarly, it is sufficient if the surface modification is applied to a necessary portion, and the surface modification may or may not be applied to the other portions thereof. However, in general, a modified surface often becomes hard and may not maintain favorable buffering properties, shock resistance, adhesion, and sealing properties. Therefore, it is better not to make the surface harder than necessary and desirable not to apply the surface modification to portions other than the necessary portion.

Therefore, the surface of the rubber member in the present example embodiment in which the difference between the nitrogen atomic percentage of the surface of the rubber member determined by the XPS analysis and the nitrogen atomic percentage of the inside of the rubber member determined by the XPS analysis is 0.5% or more and 7.5% or less, which is obtained by subtracting the latter from the former, may be not the entire surface of the rubber member of the present example embodiment but may be only a portion of the surface of the rubber member.

The rubber member of the present example embodiment usually has a thickness of about 0.5 mm at its thinnest. Considering that the rubber member can be used as a buffering member, a shock mitigation member, a pressure relaxation member, a sealing member, an adhesive member, a heat insulating member, or the like, the rubber member needs to have a certain thickness of about 0.5 mm or more.

The thickness herein is the thickness of the contact surface with a counterpart member such as a buffering member, a shock mitigation member, a pressure relaxation member, a sealing member, an adhesive member, and a heat insulating member, and it does not matter whether the thickness of the other portions of the rubber member is smaller or larger. Also, the thickness is desirably 1 mm or more.

The maximum thickness is not particularly limited, but is usually 500 mm or less, and is desirably 300 mm or less. When the rubber member is used as a sealing member, its maximum thickness is 100 mm or less, and is desirably 20 mm or less in view of the requirement for airtightness.

Description will be given of the difference between the nitrogen atomic percentage of the surface of the rubber member of the present example embodiment determined by the XPS analysis and the nitrogen atomic percentage of the inside of the rubber member determined by the XPS analysis that is 0.5% or more and 7.5% or less.

The surface of the rubber member herein literally means the surface of the rubber member, and a region of the surface to be measured by an XPS analyzer is measured on the order of nanometers (nm) (for example, within 10 nm from the surface). The inside of the rubber member herein refers to an inside away from the surface thereof by 20% or more of the thickness, and in a case where the thickness is small, it refers to an inside at least 0.2 mm or more away from the surface from a viewpoint of an actual measurement condition. To measure the inside, the surface is shaved off by machining or the surface of a sheet-form rubber member is cut away to expose the inside, and the inside is measured by an XPS analyzer. In the case of the sheet-form rubber member, when the member includes a surface-modified nitrogen-atom-rich layer on only one side, the nitrogen atomic percentage of the inside can be determined by measuring the untreated back side.

The XPS analysis is an analysis method well known to those skilled in the art, and an analysis of components on a surface can be performed using an XPS analyzer such as Quantera SXM from ULVAC-PHI, Inc. When analyzing the rubber member of the present example embodiment, in general, charge neutralization is performed by irradiation with Al Kα monochromatic X-ray (E=1486.6 eV), 20 μm in diameter, electrons and Ar ions, and detection can be performed under (Pass Energy): E=280 eV, 1 eV step (Survey), E=112 eV, 0.1 eV step (C1s, O1s, F1s, N1s, Si2p), but the invention is not limited to these conditions. For example, the nitrogen atomic percentage value of the surface of the rubber member determined by the XPS analysis can be a measured value within 10 nm from the surface, and the nitrogen atomic percentage value of the inside of the rubber member determined by the XPS analysis can be a measured value of an inner portion away from the surface thereof by 20% or more of the thickness, and the difference between the obtained nitrogen atomic percentage values can be obtained. The nitrogen atomic percentage values measured and obtained in this manner are used in the present example embodiment.

In the rubber member of the present example embodiment, the difference between the nitrogen atomic percentage of the surface of the rubber member determined by the XPS analysis and the nitrogen atomic percentage of the inside of the rubber member determined by the XPS analysis, which is obtained by subtracting the latter from the former, is 0.5% or more and 7.5% or less. If the difference is less than 0.5%, the charging suppression of a counterpart member is often insufficient. If the difference is less than 0.5% and the total nitrogen atomic percentage is high, the difference between the nitrogen atomic percentage of the surface and the nitrogen atomic percentage of the inside is very small, so that the rubber member may be insufficient in buffering properties, sealing properties, and shock resistance. If the difference exceeds 7.5%, the nitrogen atomic percentage of the surface is too high, so that the counterpart member may be highly charged in the sign opposite to the normal one, or the surface may become too hard, resulting in poor buffering properties, sealing properties, and shock resistance. A more preferable range of the difference between the nitrogen atomic percentage of the surface of the rubber member determined by the XPS analysis and the nitrogen atomic percentage of the inside of the rubber member determined by the XPS analysis, which is obtained by subtracting the latter from the former, is 1.5% or more and 4.5% or less.

In addition to the XPS analysis, the difference between the surface and the inside of the rubber member of the present example embodiment can be simply obtained also by measuring the difference between the surface and the inside using a micro hardness meter. As the micro hardness meter, a type-C indenter of a micro rubber hardness meter MD-1capa manufactured by Kobunshi Keiki Co., Ltd. can be used. In the case of hardness as well, a difference obtained by subtracting the hardness of the inside from the hardness of the surface can be used. The hardness of the rubber member used in the present example embodiment, measured using the type-C indenter of the micro rubber hardness meter MD-1capa manufactured by Kobunshi Keiki Co., Ltd., can be from 8 to 60, and desirably from 10 to 50. In the same manner as in the XPS analysis, the hardness difference is obtained by measuring the surface and the inside that has been subjected to surface processing such as machining, and calculating the difference between the measured values.

In the present example embodiment, the difference between the hardness of the surface and the hardness of the inside measured by the type-C indenter of the micro rubber hardness meter MD-1capa manufactured by Kobunshi Keiki Co., Ltd. is desirably 0.5 or more and 13.0 or less. If the difference is less than 0.5, the charging suppression of the counterpart member is often insufficient. If the difference is less than 0.5 and the entire hardness is high, the rubber member may be insufficient in buffering properties, sealing properties, and shock resistance. If the difference exceeds 13.0, the hardness of the surface is too high, so that the counterpart member may be highly charged in the sign opposite to the normal one, or the surface may become too hard, resulting in poor buffering properties, sealing properties, and shock resistance. The difference is more desirably 1.5 or more and 7.0 or less.

The rubber member of the present example embodiment that includes a foamed fluoro rubber as the base material and in which the difference between the nitrogen atomic percentage of the surface of the rubber member determined by the XPS analysis and the nitrogen atomic percentage of the inside of the member measured by the XPS analysis is 0.5% to 7.5%, which is obtained by subtracting the latter from the former, is used in contact with any one of members, each including an insulating portion, of quartz, glass, polyamides, polyamines, polyacrylamides, polyvinyl alcohols, poly-N-vinyl polymers, poly(meth)acrylic acids, cellophane, and silk, and suppresses peeling charge of the counterpart member when a contact state is broken. The degree of charging suppression can be evaluated by bringing the rubber member of the present example embodiment into contact with the counterpart member and then peeling it off, measuring a surface potential of the counterpart member, and using the magnitude of the surface potential for evaluation, for example.

Furthermore, in order to evaluate the performance of the rubber member as a buffering member, a shock mitigation member, a pressure relaxation member, a sealing member, an adhesive member, or a heat insulating member, it is possible to make a certain evaluation by checking the sealing property, for example. The foamed fluoro rubber member of the present example embodiment is a soft member having a certain degree of hardness and elasticity, and if the rubber member is found to possess adhesion and sealing properties under a certain pressure, the rubber member is considered to be favorable in terms of these performances.

Next, the second example embodiment will be described. The second example embodiment is a method for manufacturing a rubber member of the present example embodiment, in which an aminosilane agent is applied to a foamed fluoro rubber by a dipping method or a spraying method and alcohol is used as a solvent. Examples of the aminosilane agent include those described above. When the aminosilane agent is applied to an untreated foamed fluoro rubber surface, the aminosilane agent is usually diluted with the solvent in order to form a thin coating. In many cases, the agent is diluted to a few percent to about 10% or 20% by weight. The solvent for dilution is desirably alcohol, which dissolves the aminosilane agent well, has volatility, and efficiently adheres to the foamed fluoro rubber. It is also desirable to add a small amount of water. A more desirable alcohol is a monoalcohol having up to four carbon atoms, and in particular, 2-butanol, propanol, isopropanol, ethanol, or methanol is desirable. As a coating method, it is desirable to use a diluted liquid and apply the agent by a dipping method or a spraying method. As a method for coating only a necessary surface that contacts a contact member, the spraying method is preferable.

After applying a coating as described above, the solvent is dried, and the coating is thermally treated at a temperature of about 100° C. to 150° C. to fix the coating.

The third example embodiment is a method for using the rubber member of the first example embodiment of the present disclosure as a contact member that is capable of being used in contact with any one of members, each including an insulating portion, of quartz, glass, polyamides, polyamines, polyacrylamides, polyvinyl alcohols, poly-N-vinyl polymers, poly(meth)acrylic acids, cellophane, and silk, and is capable of being separated from any of the members.

The rubber member of the first example embodiment of the present disclosure contacts and is separated from any one of members of quartz, glass, polyamides, polyamines, polyacrylamides, polyvinyl alcohols, poly-N-vinyl polymers, poly(meth)acrylic acids, cellophane, and silk. More specifically, the rubber member can effectively suppress the peeling charge of these members at the time of peeling and can further effectively suppress discharge, electrostatic disturbances, and the like. For this reason, the rubber member can be used as a sealing member, a shock-resistant member, or a heat insulating member in an oil-related component in an automobile, a buffering member, a sealing member, a shock-resistant member, or a heat insulating member for a member forming a fine circuit in an electrical and electronic device, or a buffering member, a sealing member, a shock-resistant member, or a heat insulating member used for construction and daily life, that is capable of contacting and being separated from any one of members of quartz, glass, polyamides, polyamines, polyacrylamides, polyvinyl alcohols, poly-N-vinyl polymers, poly(meth)acrylic acids, cellophane, and silk, and that is capable of suppressing discharge, electrostatic disturbances, and the like.

The polyamides refer to polymers that have amide bonds as their repeating unit structures, and examples thereof include nylon 6, nylon 11, nylon 12, nylon 66, nylon 610, nylon 6T, nylon 6I, nylon 9T, nylon M5T, and nylon 612. Copolymers of these polymers are also included.

The polyamines refer to polymers that have repeating unit structures with an amine functional group. Copolymers of these polymers are also included.

The polyacrylamides refer to polymers that have repeating unit structures obtained by polymerizing acrylamide or methacrylamide monomers. Copolymers of these polymers are also included.

The polyvinyl alcohols refer to polymers that have repeating unit structures of —CH₂CH(OH)—. Copolymers of these polymers are also included.

The poly-N-vinyl polymers refer to polymers that have repeating unit structures of a polymer with an N-vinyl structure. Copolymers of these polymers are also included.

The poly(meth)acrylic acids refer to polymers that have a polymer structure of acrylic acid or methacrylic acid as repeating unit structures. Copolymers of these polymers are also included.

The cellophane refers to polymers made from viscose, and includes a modified cellophane.

The silk refers to polymers made from silk, and includes a modified silk.

### EXAMPLES

In a first example embodiment, foamed fluoro rubber sheets of 5 cm×5 cm (thicknesses are shown in the table) of DF700S-86 and AF-150 manufactured by Mitsufuku Industry Co., Ltd. were spray-coated or dip-coated (dipping time: one minute) with a solution of an aminosilane agent ((CH₃O)₂Si(CH₃)—C₃H₆—NH—C₂H₄—NH₂) dissolved in ethanol/water (90/10), and then dried at 80° C. for one hour and left stand at 120° C. for two hours to prepare samples.

The content of the aminosilane agent was changed from 2% by weight to 15% by weight, and samples with the numbers shown in the table illustrated in the FIGURE were prepared. For each spray-coated sample, the coated surface and the uncoated surface were measured by XPS using a Quantera SXM manufactured by ULVAC-PHI, Inc. under the conditions described above, the surface and the inside were subjected to an analysis of components, and the difference was obtained by subtracting the nitrogen atomic percentage of the inside from the nitrogen atomic percentage of the surface, which was recorded in the table. For each dip-coated sample, the coated surface was directly subjected to an analysis of components by XPS, and the sample was cut at the center in the thickness direction to expose the inside, and the inside was subjected to an analysis of components by XPS. For hardness, measurements were performed on the same surface and inside subjected to the analysis of components by XPS using a type-C indenter of a micro rubber hardness meter MD-1capa manufactured by Kobunshi Keiki Co., Ltd., and the hardness difference was obtained as recorded in the table illustrated in the FIGURE.

Each foamed fluoro rubber sample was cut into 20 mm×20 mm pieces to be used as samples, and evaluated for peeling charge property in the manner described below, using a piece of 50 mm×50 mm quartz glass with a thickness of 1 mm as a counterpart member.

### Measuring Method:

1. The piece of quartz glass that is 1 mm thick was placed on a grounded electrode and cleared of static electricity using an ionizer or the like.
2. The sample was subjected to the surface treatment of the present example embodiment, and the surface-treated side of the sample was brought into contact with the quartz glass.
3. After contact for 300 seconds under a load of 800 g (load 2 g/mm²), the sample was peeled off from the quartz glass.
4. The potential of the quartz glass was measured three times using a surface potential meter (Trek Model 34). An average of measured values was used as the measurement value.
5. The sample with a potential of +300V to −300V was rated as very good, the sample with a potential of +500V to +300V or −300V to −500V was rated as good, and the sample with a potential of larger than +500V or with a potential of less than −500V was rated as bad.

For sealing property, each sample with the thickness described in the table was prepared, and an area of 40 mm×40 mm was punched out therefrom to leave the outer shape, thereby to prepare a square-framed sample with outer dimensions of 50 mm×50 mm and a frame width of 5 mm. A hole with a diameter of 2 cm was made in an upper part of an acrylic pressure-resistant vacuum chamber, and the part was sealed. To seal, a piece of quartz glass of 100 mm×100 mm with a thickness of 5 mm was placed on top of the square-framed foamed fluoro rubber sample with the outer dimensions of 50 mm×50 mm and the frame width of 5 mm, and a weight of 1 kg was placed on the quartz glass to apply pressure from above. In this state, the pressure-resistant vacuum chamber was depressurized with a vacuum pump so that a difference between the pressure inside the chamber and the atmospheric pressure was at −0.1 k to −0.45 kPa. After leaving the sample for five minutes, if a change of the pressure difference was less than 50%, the sample was rated as good, and if the change of the pressure difference was 50% or more, the sample was rated as bad.

However, the following points should be noted:
1) In each of the foamed fluoro rubber samples before coating used in Examples and Comparative Examples, the porosity was calculated by a method of measuring the weight against a certain volume, and the calculated value fell within a range of 58% to 89%. In addition, when each of the samples was measured for hardness before coating using the type-C indenter of the micro rubber hardness meter MD-1capa manufactured by Kobunshi Keiki Co., Ltd., each of the measured values fell within a range of 12 to 22.
2) The open cell ratio was measured by the method described in Japanese Patent Application Laid-Open No. 2022-60895.
3) Among the samples in Examples, AF-150 was used for the sample of Example 4, and DF700S-86 was used for other Examples.
4) The sample in Comparative Example 3 was prepared by applying a coating by a dipping method. The dipping time was 96 hours so that the sample was impregnated with the aminosilane agent to the inside.
5) Before coating, porous portions of the foamed fluoro rubber sheet of the sample in Example 6 were pierced several times with a pinholder used in flower arrangement so that the open cell ratio was 47%.
6) For the sample in Example 8, the solvent for the coating liquid was isopropanol instead of ethanol.
7) The material for the bulk of the fluoro rubber sample in Comparative Example 6 was polyvinylidene fluoride.

In a second example embodiment, the samples in Examples 4 to 9 according to the first example embodiment were evaluated for the peeling charge property and the sealing property using a counterpart member of soda lime glass. All of these samples were rated as very good for the peeling charge property and as good for the sealing property.

The samples in Comparative Examples 1 to 6 according to the first example embodiment were evaluated for the peeling charge property and the sealing property using a counterpart member of soda lime glass. The results were the same as those in the first example embodiment.

In a third example embodiment, the samples in Examples 4 to 9 according to the first example embodiment were evaluated for the peeling charge property and the sealing property using counterpart members of nylon 6 and nylon 66. For both of the nylons, all of these samples were rated as very good for the peeling charge property and as good for the sealing property.

The sample of Comparative Example 1 according to the first example embodiment was evaluated for the peeling charge property and the sealing property using a counterpart member of nylon 66. The sample was rated as bad for the charging property and as good for the sealing property.

The sample of Comparative Example 3 according to the first example embodiment was evaluated for the peeling charge property and the sealing property using a counterpart member of nylon 6. The sample was rated as very good for the peeling charge property and as bad for the sealing property.

In a fourth example embodiment, the sample of Example 3 according to the first example embodiment was evaluated for the peeling charge property and the sealing property using a counterpart member of polyvinyl alcohol. The sample was rated as very good for the peeling charge property and as good for the sealing property.

In a fifth example embodiment, the sample of Example 3 according to the first example embodiment was evaluated for the peeling charge property and the sealing property using counterpart members of poly(tert-butyl acrylamide) and poly(N-vinylpyrrolidone). For both of the counterpart members, the sample was rated as very good for the peeling charge property and as good for the sealing property.

In a sixth example embodiment, the sample of Example 9 according to the first example embodiment was evaluated for the peeling charge property and the sealing property using a counterpart member that is a polycarbonate substrate coated with polyallylamine. The sample was rated as very good for the peeling charge property and as good for the sealing property.

In a seventh example embodiment, the sample of Example 7 according to the first example embodiment was evaluated for the peeling charge property and the sealing property using a counterpart member that is a polycarbonate substrate coated with silk. The sample was rated as very good for the peeling charge property and as good for the sealing property.

In an eighth example embodiment, the sample of Example 5 according to the first example embodiment was evaluated for the peeling charge property and the sealing property using a counterpart member of cellophane. The sample was rated as very good for the peeling charge property and as good for the sealing property.

In a ninth example embodiment, the sample of Example 5 was evaluated for the peeling charge property and the sealing property using a counterpart member that is a polycarbonate substrate coated with polyacrylic acid. The sample was rated as very good for the peeling charge property and as good for the sealing property.

In a tenth example embodiment, a foamed fluoro rubber sheet having a similar porosity and a similar open cell ratio as those of the foamed fluoro rubber sheet used in the sample of Example 5 according to the first example embodiment and not containing carbon black was subjected to a similar surface treatment as the surface treatment in Example 5. When an analysis of components by XPS was performed on the foamed fluoro rubber sheet, a difference obtained by subtracting the nitrogen atomic percentage of the inside from the nitrogen atomic percentage of the surface was 1.8%, and a difference in hardness between the inside and the surface was 2.4. The foamed fluoro rubber sheet was evaluated in the same manner as in the first example embodiment, and rated as good for the peeling charge property and as good for the sealing property.

### SUMMARY OF EXAMPLE EMBODIMENTS

The disclosure herein includes a rubber member, a method for manufacturing a rubber member, and a method for using a rubber member, which are the following items.

### Item 1

1. A rubber member comprising foamed fluoro rubber as a base material,
wherein a difference between a nitrogen atomic percentage of a surface of the rubber member determined by an X-ray photoelectron spectroscopy (XPS) analysis and a nitrogen atomic percentage of an inside of the rubber member determined by the XPS analysis is 0.5% or more and 7.5% or less.

### Item 2

2. The rubber member according to Item 1, wherein an open cell ratio is 50% or less.

### Item 3

3. The rubber member according to Item 1 or 2, wherein the rubber member has a porosity of 30% or more and 95% or less.

### Item 4

4. The rubber member according to any one of Items 1 to 3,
wherein a value of the nitrogen atomic percentage of the surface of the rubber member determined by the XPS analysis is a measured value within 10 nm from the surface, and
wherein a value of the nitrogen atomic percentage of the inside of the rubber member determined by the XPS analysis is a measured value away from the surface by 20% or more of a thickness.

### Item 5

5. The rubber member according to any one of Items 1 to 4, containing carbon black.

### Item 6

6. The rubber member according to any one of Items 1 to 5, wherein the difference between the nitrogen atomic percentage of the surface of the rubber member determined by the XPS analysis and the nitrogen atomic percentage of the inside of the rubber member determined by the XPS analysis is 1.5% or more and 4.5% or less.

### Item 7

7. A method for manufacturing a rubber member, the method comprising:
obtaining a rubber member by coating foamed fluoro rubber with an aminosilane agent using alcohol as a solvent,
wherein a difference between a nitrogen atomic percentage of a surface of the rubber member determined by an XPS analysis and a nitrogen atomic percentage of an inside of the rubber member determined by the XPS analysis is 0.5% or more and 7.5% or less.

### Item 8

8. The method for manufacturing a rubber member according to Item 7, wherein the coating is performed by a dipping method or a spraying method.

### Item 9

9. The method for manufacturing a rubber member according to Item 7 or 8, wherein the obtaining the rubber member includes thermally treating the rubber member at a temperature of 100° C. to 150° C.

### Item 10

10. The method for manufacturing a rubber member according to any one of Items 7 to 9, wherein an open cell ratio is 50% or less.

### Item 11

11. The method for manufacturing a rubber member according to any one of Items 7 to 10, wherein the rubber member contains carbon black.

### Item 12

12. The method for manufacturing a rubber member according to any one of Items 7 to 11, wherein the difference between the nitrogen atomic percentage of the surface of the rubber member determined by the XPS analysis and the nitrogen atomic percentage of the inside of the rubber member determined by the XPS analysis is 1.5% or more and 4.5% or less.

### Item 13

13. A method for using the rubber member according to any one of Items 1 to 6, wherein the rubber member is used as a contact member that is capable of being used in contact with any one of members, each including an insulating portion, of quartz, glass, polyamides, polyamines, polyacrylamides, polyvinyl alcohols, poly-N-vinyl polymers, poly(meth)acrylic acids, cellophane, and silk and is capable of being separated from any of the members.

According to the present disclosure, a rubber member that suppresses charging at the time of being peeled off from a member in contact therewith can be provided.

While the present disclosure has been described with reference to example embodiments, it is to be understood that the invention is not limited to the disclosed example embodiments. The scope of the following claims is to be accorded the broadest interpretation so as to encompass all such modifications and equivalent structures and functions.

This application claims the benefit of Japanese Patent Application No. 2024-028192, filed Feb. 28, 2024, which is hereby incorporated by reference herein in its entirety.

What is claimed is:

1. A rubber member comprising:
foamed fluoro rubber as a base material,
wherein a difference between a nitrogen atomic percentage of a surface of the rubber member determined by an X-ray photoelectron spectroscopy (XPS) analysis and a nitrogen atomic percentage of an inside of the rubber member determined by the XPS analysis is 0.5% or more and 7.5% or less.

2. The rubber member according to claim 1, wherein an open cell ratio is 50% or less.

3. The rubber member according to claim 1, wherein the rubber member has a porosity of 30% or more and 95% or less.

4. The rubber member according to claim 1,
wherein a value of the nitrogen atomic percentage of the surface of the rubber member determined by the XPS analysis is a measured value within 10 nm from the surface, and
wherein a value of the nitrogen atomic percentage of the inside of the rubber member determined by the XPS analysis is a measured value away from the surface by 20% or more of a thickness.

5. The rubber member according to claim 1, containing carbon black.

6. The rubber member according to claim 1, wherein the difference between the nitrogen atomic percentage of the surface of the rubber member determined by the XPS analysis and the nitrogen atomic percentage of the inside of the rubber member determined by the XPS analysis is 1.5% or more and 4.5% or less.

7. A method for manufacturing a rubber member, the method comprising:
obtaining a rubber member by coating foamed fluoro rubber with an aminosilane agent using alcohol as a solvent,
wherein a difference between a nitrogen atomic percentage of a surface of the rubber member determined by an XPS analysis and a nitrogen atomic percentage of an inside of the rubber member determined by the XPS analysis is 0.5% or more and 7.5% or less.

8. The method for manufacturing a rubber member according to claim 7, wherein the coating is performed by a dipping method or a spraying method.

9. The method for manufacturing a rubber member according to claim 7, wherein the obtaining the rubber member includes thermally treating the rubber member at a temperature of 100° C. to 150° C.

10. The method for manufacturing a rubber member according to claim 7, wherein an open cell ratio is 50% or less.

11. The method for manufacturing a rubber member according to claim 7, wherein the rubber member contains carbon black.

12. The method for manufacturing a rubber member according to claim 7, wherein the difference between the nitrogen atomic percentage of the surface of the rubber member determined by the XPS analysis and the nitrogen atomic percentage of the inside of the rubber member determined by the XPS analysis is 1.5% or more and 4.5% or less.

13. A method for using the rubber member according to claim 1,
wherein the rubber member is used as a contact member that is capable of being used in contact with any one of members selected from the group consisting of quartz, glass, polyamides, polyamines, polyacrylamides, polyvinyl alcohols, poly-N-vinyl polymers, poly(meth)acrylic acids, cellophane, and silk, each of the members including an insulating portion, and
wherein the rubber member is capable of being separated from any of the members.
